(19) United States
(12) Patent Application Publication
(10) Pub. No.: US 2022/0151195 A1
(43) Pub. Date: May 19, 2022

(54) STAINLESS STEEL LITTER BOX AND METHOD THEREFOR

(71) Applicant: JACKLYN KI, LOS ANGELES, CA (US)

(72) Inventor: JACKLYN KI, LOS ANGELES, CA (US)

(21) Appl. No.: 17/515,905

(22) Filed: Nov. 1, 2021

Related U.S. Application Data
(60) Provisional application No. 63/115,906, filed on Nov. 19, 2020.

(51) Int. Cl. A01K 1/01

(52) U.S. Cl. CPC A01K 1/0107

(57) ABSTRACT

An animal litter device has a container. The container has a floor. A sidewall extends straight up from the floor forming an open top area. A rounded edge is formed at an intersection of the floor and sidewall. The rounded edge prevents a buildup of materials stored in the animal litter device. A “U” shaped opening is formed in the sidewall in a front area of the animal liter device. The floor and sidewalls are formed of stainless steel.

### RELATED APPLICATIONS

This patent application is related to U.S. Provisional Application No. 63/115,906 filed Nov. 19, 2020, entitled “STAINLESS STEEL LITTER BOX AND METHOD THEREFOR” in the name of Jacklyn Ki, and which is incorporated herein by reference in its entirety. The present patent application claims the benefit under 35 U.S.C. § 119(e).

### TECHNICAL FIELD

The present application generally relates to an animal litter box, and, more particularly, to an antimicrobial and commercial grade stainless steel cat litter box.

### BACKGROUND

Litter boxes may be commonly used by indoor animals, such as cats, to collect the animal's urine and feces. In general, most litter boxes may be formed of a plastic material. Granular kitty litter may be placed in the bottom of the litter box. The granular kitty litter may be used to absorb moisture and odor caused by the animal's bodily functions. Further, since cats like to use their paws in a backward sweeping motion to cover their feces, the kitty litter may satisfy a cat's instinctive desire to hide their scent by allowing them to bury their waste.

Even with proper cleaning and disinfecting of a litter box, it is generally recommended that the litter box be replaced with a new one once or twice a year. Plastic litter boxes may be easily scratched and damaged by the cat using the litter box. Channels formed by these scratches may harbor odor and bacteria. Further, cat urine is highly acidic. The acidity of the urine may have a tendency to break down/degrade the plastic material forming the litter box allowing mold and other bacteria to form. In general, these discarded litter boxes end up in landfills and will not biodegrade to any significant degree.

Therefore, it would be desirable to provide a litter box that overcome the above problems.

### SUMMARY

In accordance with one embodiment, an animal litter device is disclosed. The animal litter device has a container. The container has a floor. A sidewall extends straight up from the floor forming an open top area. A rounded edge is formed at an intersection of the floor and sidewall. The rounded edge prevents a buildup of materials stored in the animal litter device. A “U” shaped opening is formed in the sidewall in a front area of the animal liter device. The floor and sidewall of the device are formed of stainless steel.

In accordance with one embodiment, an animal litter container is disclosed. The animal litter container has a floor. A sidewall extends up from the floor forming an open top area. A rounded curved edge is formed at an intersection of the floor and sidewall. The rounded curved edge preventing a buildup of materials stored in the animal litter device. A “U” shaped opening is formed in the sidewall in a front area of the animal liter device. The floor and sidewall of the device are formed of at least 300 series stainless steel.

In accordance with one embodiment, an animal litter device is disclosed. The animal litter device has a floor. A sidewall extends up from around a perimeter of the floor forming a cylindrical container with an open top area. The container is seamless and creviceless and formed of at least 300 series stainless steel. A rounded curved edge is formed at an intersection of the floor and sidewall, the rounded edge preventing a buildup of materials stored in the animal litter device. A “U” shaped opening is formed in the sidewall in a front area of the animal liter device and at least 4″ above the floor. A fill line is formed on the container. A pair of handle openings is formed on opposing sides of the sidewall.

### BRIEF DESCRIPTION OF THE DRAWINGS

The present application is further detailed with respect to the following drawings. These figures are not intended to limit the scope of the present application but rather illustrate certain attributes thereof.

FIG. 1 is a perspective view of an exemplary embodiment of a litter box in accordance with one aspect of the present application;

FIG. 2 is a front view of an exemplary embodiment of the litter box of FIG. 1 in accordance with one aspect of the present application; and

FIG. 3 is a side view of an exemplary embodiment of the litter box of FIG. 1 in accordance with one aspect of the present application.

### DESCRIPTION OF THE APPLICATION

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

The present disclosure relates to an improved litter box. The improved litter box may be formed of rust proof material. The improved litter box may be formed without seams and crevices to prevent crevice corrosion. The improved litter box may be formed of 300 type stainless steel and thus will not absorb odors, grow bacteria, mold, leave stains, rust or build up residues like the plastic, rubber, and low-grade stainless-steel litter boxes.

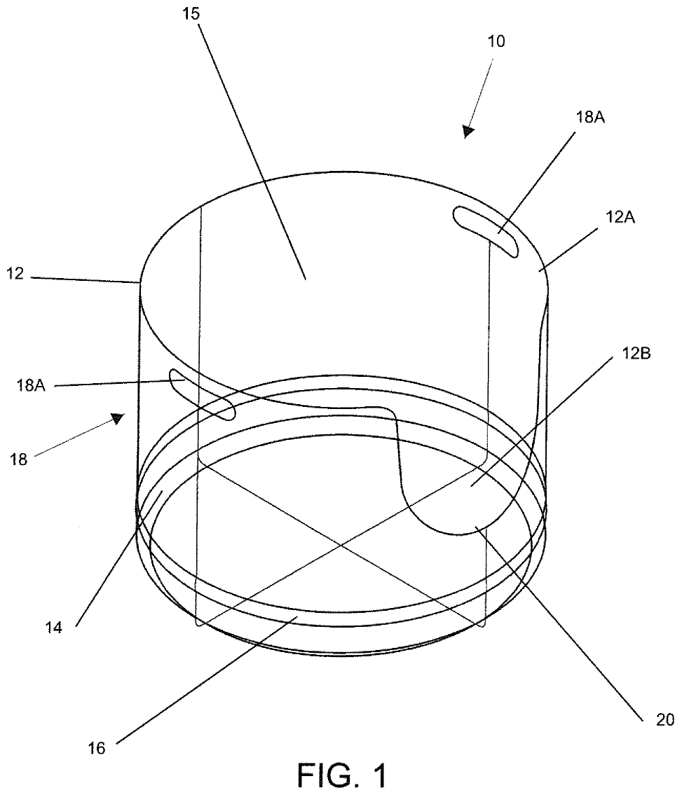

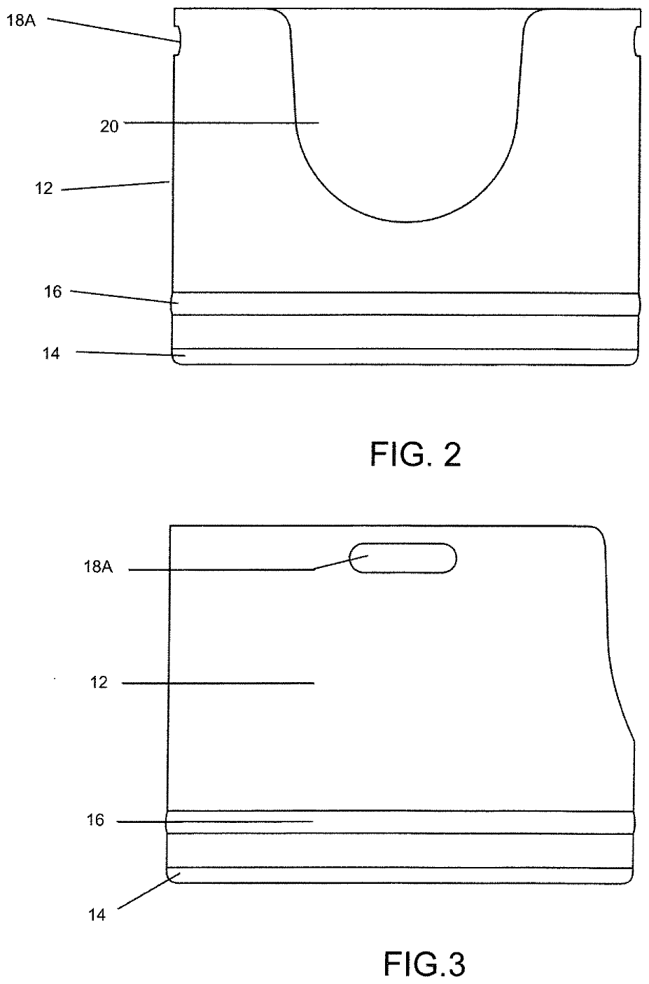

Referring to the FIG. 1, a perspective view of a litter box 10 may be seen. The litter box 10 may be formed of a container 12. The container 12 may have an open top area 15 formed therein. In the present embodiment, the container 12 may be circular in shape. The circular shape of the container 12 may provide a container 12 having no corners. Corners may present an issue in prior art litter boxes. The corner areas are harder to clean and may be an area where the litter and animal waste collect. Thus, the circular shape of the container 12 may be easier to clean and may prevent any build up or difficulty in removing the litter and animal waste from the container 12.

In accordance with one embodiment, the container 12 may be formed of a floor 12B. A side wall 12A may extend up from around a perimeter of the floor 12B forming the container 12 with the open top area 15.

Located in a bottom interior of the container 12 may be a rounded/curved edge 14 (hereinafter rounded edge). The rounded edge 14 may be formed where the side wall 12A of the container 12 meets with the floor 12B of the container 12. The rounded edge 14 be easier to clean and may prevent any build up or difficulty in removing the litter and animal waste from the container 12. Most prior art litter boxes may use a container having a sharper edge formed between the side wall of the container and the floor. The sharper edge area is more difficult to clean and may be an area where the litter and animal waste collect.

A fill line 16 may be formed on the container 12. In accordance with one embodiment, the fill line 16 may be formed on the side wall 12A. The fill line 16 may indicate an amount of kitty litter that should be placed in the interior of the container 12. The fill line 16 may be formed two to three inches above the floor 12B of the container 12. In accordance with one embodiment, the fill line 16 may be embossed along a perimeter of the container 12. The fill line 16 may be formed either along an exterior perimeter of the container 12 or an interior perimeter of the container 12. In accordance with one embodiment, the fill line 16 may be formed along an interior perimeter of the container 12 to allow one to more easily see the fill line 16 when adding the kitty litter to the container 12. Embossing the fill line 16 may protect the fill line 16 from damage such as scratching from an animal and normal wear and tear thereby allowing the fill line 16 to last a longer period of time.

A pair of handles 18 may be fowled on opposing sides of the container 12. The handles 18 may be used to pick-up and move the container 12. In accordance with one embodiment, the handles 18 may be a pair of elongated oval openings 18A formed on opposing sides of the container 12 such as a left side and a right side of the container 12.

An opening 20 may be formed in a front area of the container 12. The opening 20 may allow an animal to enter the interior of the container 12. In accordance with one embodiment, the opening 20 may be a “U” shape opening. The bottom of the “U” shape opening 20 should be of sufficient height to keep the kitty litter within the interior of the container 12 but not be too high to prevent the animal from entering. In accordance with one embodiment, the bottom of the “U” shape opening 20 may be a minimum of four inches above the floor 12B of the container 12.

The letters pH stand for potential of hydrogen. A pH level is effectively a measure of the concentration of hydrogen ions (that is, protons) in a substance. Normal cat urine pH should be in the range of 6 to 6.5. However, various conditions and/or diet can either raise or lower urine pH in cats as disclosed in the article published at https://academic.oup.com/jn/article/132/6/1754S/4687798. A lower pH generally means that the cat urine is more acidic. A higher pH generally means that the cat urine is more alkaline. A major consideration is that abnormal urinary pH can promote the formation of crystals/stones that can irritate and/or obstruct the urinary tract of the cat. Further, more acidic urine may have a tendency to speed up the deterioration of prior art litter boxes.

Many people may be under the assumption that all stainless steel is resistant to corrosion. However, this is generally not true. The lower the grade of the stainless steel, the higher the rate of corrosion that may occur. For example, many inexpensive stainless steel products you may find on Amazon® and Ikea® may be made of 201 or 200 series stainless steel. It may be hard to tell from the outside since all stainless steel may look the same. However, 200 series stainless steel eventually rust within 1-2 years even if they are not contacted with liquid but just sitting in a humid environment.

It has been shown, that certain solutions, may cause corrosion cracking in stainless steel. When passive metals such as the stainless steels corrode, the corrosion develops where passivity has been destroyed. This may occur at very small areas and result in a pitted surface. Once the passivity has been lost at a local spot, this area will be anodic to the remaining passive surface.

As disclosed in an article which may be found at https://www.parrinst.con-./wp-content/uploads/downloads/2011/07/Parr_Stainless-Steels-Corrosion-Info.pdf, increasing carbon content tends to increase susceptibility to sensitization. Holding the carbon content to a maximum of 0.03 percent, as found in higher 300 types of stainless steel, may be sufficient to avoid sensitization. Additions of titanium or columbium may also serve to inhibit the development of sensitization. Therefore, if the low carbon grades are not used, 300 types may be recommended for use in corrosive environments.

Thus, the present container 12 may be formed of a seamless, crevice-free, rivet-free and austentic 300 type of stainless steel. A container formed of 300 type stainless steel will not absorb odors, grow bacteria, mold, leave stains, rust or build up residues like the plastic, rubber, and low-grade stainless steel litter boxes currently available. In accordance with one embodiment, the container 12 may be formed of 316 “marine” grade stainless steel.

Having a seamless, crevice-free, rivet-free container 12 may be important as grain boundaries have less resistance to corrosion. Welding and drilling operations, for example, may leave an area near the welds and cuts in such a corrosion-susceptible or “sensitized” condition. The intergranular corrosion of a sensitized steel can be insidious, in that after such attack the steel sometimes appears relatively sound, but on more detailed examination may be found to possess very little strength.

While embodiments of the disclosure have been described in terms of various specific embodiments, those skilled in the art will recognize that the embodiments of the disclosure may be practiced with modifications within the spirit and scope of the claims

What is claimed is:

1. An animal litter device, comprising:
a container comprising:
a floor;
a sidewall extending straight up from the floor forming an open top area;
a rounded edge formed at an intersection of the floor and sidewall, the rounded edge preventing a buildup of materials stored in the animal litter device; and
a “U” shaped opening formed in the sidewall in a front area of the animal liter device;
wherein the floor and sidewall are formed of stainless steel.

2. The animal litter device of claim 1, comprising a fill line formed on the sidewall.

3. The animal litter device of claim 1, comprising a fill line formed on the sidewall at least two inches above the floor.

4. The animal litter device of claim 1, comprising a pair of handle openings formed on opposing sides of the sidewall.

5. The animal litter device of claim 1, wherein the floor and sidewalls are formed of 300 series stainless steel.

6. The animal litter device of claim 1, wherein the floor and sidewalls are formed of 316 marine grade stainless steel.

7. The animal litter device of claim 1, wherein the container is cylindrical shape.

8. The animal litter device of claim 1, wherein the container is seamless and creviceless.

9. An animal litter container, comprising:
a floor;
a sidewall extending up from the floor forming an open top area;
a rounded curved edge formed at an intersection of the floor and sidewall, the rounded edge preventing a buildup of materials stored in the animal litter device; and
a “U” shaped opening formed in the sidewall in a front area of the animal liter device;
wherein the floor and sidewall are formed of at least 300 series stainless steel.

10. The animal litter container of claim 9, comprising a fill line formed on the sidewall.

11. The animal litter container of claim 9, comprising a fill line formed in an interior of the container along a perimeter of the sidewall.

12. The animal litter container of claim 9, comprising a fill line formed on the sidewall at least two inches above the floor.

13. The animal litter container of claim 9, comprising a pair of handle openings formed on opposing sides of the sidewall.

14. The animal litter container of claim 9, wherein the floor and sidewalls are aimed of 316 marine grade stainless steel.

15. The animal litter container of claim 9, wherein the container is cylindrical shape.

16. The animal litter container of claim 9, wherein the container is seamless and creviceless.

17. An animal litter device, comprising:
a floor;
a sidewall extending up from around a perimeter of the floor forming a cylindrical container with an open top area, wherein the container is seamless and creviceless and formed of at least 300 series stainless steel;
a rounded curved edge formed at an intersection of the floor and sidewall, the rounded edge preventing a buildup of materials stored in the animal litter device;
a “U” shaped opening formed in the sidewall in a front area of the animal liter device and at least 4″ above the floor;
a fill line formed on the container; and
a pair of handle openings formed on opposing sides of the sidewall.

18. The animal litter container of claim 17, comprising a fill line formed in an interior of the container along a perimeter of the sidewall.

19. The animal litter container of claim 17, comprising a fill line formed on the sidewall at least two inches above the floor.

20. The animal litter container of claim 17, wherein the floor and sidewalls are fowled of 316 marine grade stainless steel.
